(19) United States
(12) Patent Application Publication
(10) Pub. No.: US 2011/0103304 A1
(43) Pub. Date: May 5, 2011

(54) PACKET BUFFERING METHOD AND APPARATUS FOR REDUCING PACKET LOSS IN PROXY MOBILE IPv6

(76) Inventors: Hong Seok Jeon, Daejeon (KR); Junghoon Jee, Daejeon (KR); Chang Min Park, Daejeon (KR)

(21) Appl. No.: 12/742,606

(22) PCT Filed: Sep. 3, 2008
(86) PCT No.: PCT/KR08/05173

§ 371 Date: May 12, 2010

(30) Foreign Application Priority Data
Sep. 22, 2008 (KR) 10-2007-0115226

(51) Int. Cl. H04W 4/00

(52) U.S. Cl. 370/328

(57) ABSTRACT

Disclosed are a packet buffering apparatus and method for reducing packet loss in a proxy mobile IPv6, which include a first Mobile Access Gateway (MAG) requesting a Local Mobility Anchor (LMA) for packet buffering when outgoing Mobile Node (MN) being served by the MAG is detected, and the LMA for buffering the packet transmitted to the corresponding MN when receiving a request for the packet buffering.

### TECHNICAL FIELD

The present invention relates to a packet buffering method and apparatus for reducing packet loss in a proxy mobile Internet Protocol version 6 (IPv6), and more particularly, to a packet buffering method and apparatus for reducing packet loss in an IPv6 based-radio access network, which may buffer a packet to be transmitted from a Local Mobility Anchor (LMA) to a Mobile Node (MN) when the MN is moved between Mobile Access Gateways (MAGs).

This work was supported by the IT R&D program of MIC/IITA. [2007-P10-01, A Study on Mobility Management in Next Generation Mobile Networks]

### BACKGROUND ART

The present invention relates to a packet buffering method and apparatus for reducing packet loss in a proxy mobile Internet Protocol version 6 (IPv6), and more particularly, to a packet buffering method and apparatus for reducing packet loss in an IPv6-based radio access network.

As a Mobile Node (MN) is moved, according to Request for Comments (RFC) 3344 standardized in an IETF (Internet Engineering Task Force), ‘IP Mobility Support for IPv4’ (Mobile IPv4) and RFC 3775, and ‘Mobility Support in IPv6’ (Mobile IPv6), location information of the MN may be directly registered in a Home Agent (HA), thereby updating a data path depending on the mobility of the MN. The mobility of the Mobile IPv4/Mobile IPv6 may request the MN for performing separate functions with respect to the corresponding operation and management of various information used for Mobile IPv4/Mobile IPv6 operations. A purpose of the proxy mobile IP is to provide IP mobility services based on a network without requesting the MN for the above-described requirements. Specific components of a network in the proxy mobile IP (for example, access point or base station) may detect the mobility of the MN and perform a location information registration process on behalf of the MN.

FIG. 1 is a flowchart illustrating operations of a Proxy Mobile IPv6 standardized in the IETF NETLMM working group. Referring to FIG. 1, a Proxy Mobile IPv6 Domain (PMIPv6 Domain) includes a Mobile Node (MN) 100, a Mobile Access Gateway (MAG) 102, and a Local Mobility Anchor (LMA) 104.

The PMIPv6 Domain may denote a range of an access network providing IP mobility services to the MN 100 using a proxy mobile IPv6 scheme. The LMA 104 may have a Home Agent (HA) function for managing location information of all MNs being in service within the corresponding PMIPv6 Domain. The location information of the MN 100 in the LMA 104 may adopt an IP address of the MAG 102 in which the MN is currently in service as a Care of Address (CoA) to manage in a Binding Cache Entry (BCE) form. Since the LMA 104 is structured to be located in the upper level of data paths of all MAGs, a path of data to be transmitted to the MN 100 is re-routed as the MN 100 is moved between the MAGs, thereby supporting the IP mobility service. The LMA 104 may manage MN-Home Network Prefix (MN-HNP) information for each MN, so that it is simulated as the MN 100 is always in service in an identical sub-network although the MN 100 is moved between the MAGs within the PMIPv6 Domain (that is, between sub-networks). The MAG 102 may detect connection of the MN with a Border Router (or Border Layer 2 device) of the access network, and serve to register the location information of the corresponding MN 100 in the LMA 104. For the purpose of registering the location information, the MAG may use Proxy Binding Update/Proxy Binding Acknowledgement (PBU/PBA) messages, that is, expansion of Binding Update/Binding Acknowledgement (BU/BA) messages of the existing Mobile IPv6. The MN 100 being in service within the PMIPv6 Domain may be divided using an identifier such as a Network Access Identifier (NAI) or a Fully Qualified Domain Name (FQDN), which is used as an identifier used for acquiring supplementary information of the MN such as MN-HNP information and address generation method of the corresponding MN, and a roaming policy. It is assumed that the supplementary information of the MN is generally stored in an Authentication, Authorization and Accounting (AAA) server, and all network nodes within the PMIPv6 Domain are capable of accessing the AAA server.

When the MN 100 is connected with the PMIPv6 Domain in operation 106, the corresponding MAG may acquire identifier information of the MN (MN-Id) through an authorization procedure. The MAG 102 may acquire the supplementary information of the MN 100 through a communication with the AAA server using the identifier information of the MN when detecting connection of the MN 100 with the MAG 102 in operation 108, and then register the location information of the MN 100 in the LMA 104 through a PBU message 110 and a PBA message 114 in operation 112. An IP tunnel 118 used for data transmission of the MN 100 may be generated between the LMA 104 and the MAG 102 after a registration procedure is successfully performed by receiving the PBA message 114 from the MAG 102 in operation 116, and then routing information for the LMA 104 and the MAG 102 is added in the LMA 104 and the MAG 102, respectively.

Next, the MAG 102 may transmit a Router Advertisement (RA) message 122 for providing, to the MN, information (Prefix, Hop Limit Value, Address Configuration mode) about the sub-network for advertising or managing transmission by the sub-network in response to a Router Solicitation (RS) message 120, and thereby the MN 100 may compose an IP address in operation 124. Meanwhile, the MN 100 may transmit the RS message 120 to the MAG 102 in order to quickly receive the RA message 122 when failing to receiving the RA message 122 within a given time interval.

The above-described processes may be repeatedly performed as the MN 100 is moved between the MAGs within the PMIPv6 Domain.

The proxy mobile IPv4 is to provide IP mobility services based on a network without participation of the MN in the IPv4 based-access network.

The proxy mobile IPv6 may reduce deterioration of performance of the IP mobility service due to delay of a movement detection procedure of the existing Mobile IPv6, delay of a CoA configuration procedure, delay of a location information binding update procedure, and the like. However, there still remains a problem of the performance deterioration of the IP mobility service due to delay of mobility procedure of layer 2. Also, movement between the existing networks or delay occurring due to an access authentication process may aggravate the delay of mobility procedure of the layer 2.

Thus, there is a need for an apparatus and method for minimizing packet loss of the MN due to delay of the IP mobility service capable of occurring in the proxy mobile IPv6.

### DISCLOSURE OF INVENTION

### Technical Problem

An aspect of the present invention provides a packet buffering method and apparatus for reducing packet loss in a proxy mobile Internet Protocol version 6 (IPv6).

Another aspect of the present invention provides a packet buffering method and apparatus for reducing packet loss in an IPv6 based-radio access network, which may buffer a packet to be transmitted from a Local Mobility Anchor (LMA) to a Mobile Node (MN) when the MN is moved between Mobile Access Gateways (MAGs).

Still another aspect of the present invention provides a packet buffering method and apparatus, which may request a LMA for buffering a packet transmitted to a MN when the MN is out of service the MAG provides.

### TECHNICAL SOLUTION

According to an aspect of the present invention, there is provided a method for buffering a packet of a Local Mobility Anchor (LMA) in a network based on a proxy mobile Internet Protocol (IP), the method including: receiving a request for packet buffering when detecting an outgoing mobile node from a first Mobile Access Gateway (MAG); and buffering packets being transmitted to the corresponding mobile node when receiving the request for the packet buffering.

According to another aspect of the present invention, there is provided a method for reducing packet loss of a MAG in a network based on a proxy mobile IP, the method including: ascertaining whether a mobile node served by the MAG has been detached; and requesting a LMA for packet buffering when the outgoing mobile node is detected according to the ascertainment.

According to still another aspect of the present invention, there is provided a network based on a proxy mobile IP for reducing packet loss, the network including: a first MAG for requesting a LMA for packet buffering when a mobile node served by the MAG has been detached; and the LMA for buffering a packet being transmitted to the corresponding mobile node when receiving the request for the packet buffering.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. Therefore, it is intended that the scope of the invention be defined by the claims appended thereto and their equivalents.

### BRIEF DESCRIPTION OF THE DRAWINGS

FIG. 1 is a flowchart illustrating operations of a proxy mobile Internet Protocol version 6 (IPv6) standardized in the IETF NETLMM working group;

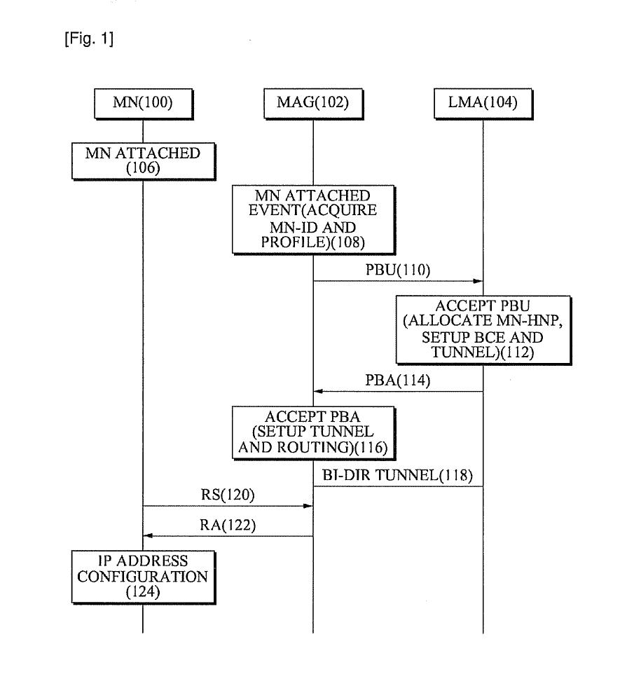

FIG. 2 is a diagram illustrating a proxy mobile IPv6-based network structure for packet buffering according to an exemplary embodiment of the present invention;

FIG. 3 is a flowchart illustrating a flow of a message for packet buffering when a mobile node is moved between Mobile Access Gateways (MAGs) in a proxy mobile IPv6 based-network according to an exemplary embodiment of the present invention;

FIG. 4 is a diagram illustrating a format of a Proxy Binding Update (PBU) message according to an exemplary embodiment of the present invention;

FIG. 5 is a diagram illustrating a format of a Proxy Binding Acknowledgement (PBA) message according to an exemplary embodiment of the present invention;

FIG. 6 is a flowchart illustrating a packet buffering requesting process of a MAG in a proxy mobile IPv6 network according to an exemplary embodiment of the present invention; and

FIG. 7 is a flowchart illustrating a packet buffering process of a Local Mobility Anchor (LMA) in a proxy mobile IPv6 network according to an exemplary embodiment of the present invention.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

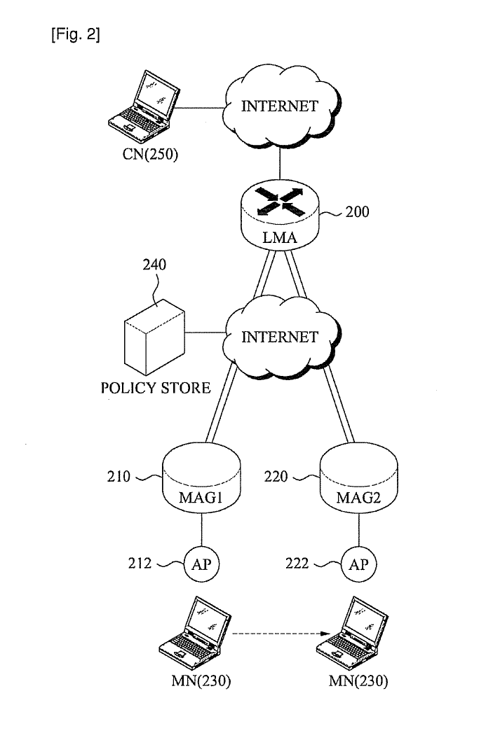

The present invention relates to a packet buffering method and apparatus for reducing packet loss in a proxy mobile Internet Protocol version 6 (IPv6) based-radio access network, in which a Local Mobility Anchor (LMA) buffers packets destined for a Mobile Node (MN) when the MN moves between Mobile Access Gateways (MAGs), and the apparatus will be described in detail with reference to FIG. 2.

FIG. 2 is a diagram illustrating a proxy mobile IPv6-based network structure for packet buffering according to an exemplary embodiment of the present invention. Referring to FIG. 2, the proxy mobile IPv6 based-network of the present exemplary embodiment of the invention includes a Local Mobility Anchor (LMA) 200, a first Mobile Access Gateway (MAG) 210, a first Access Point (AP) 212, a second MAG 220, a second AP 222, a Mobile Node (MN) 230, a policy store 240, and a correspondent node 250.

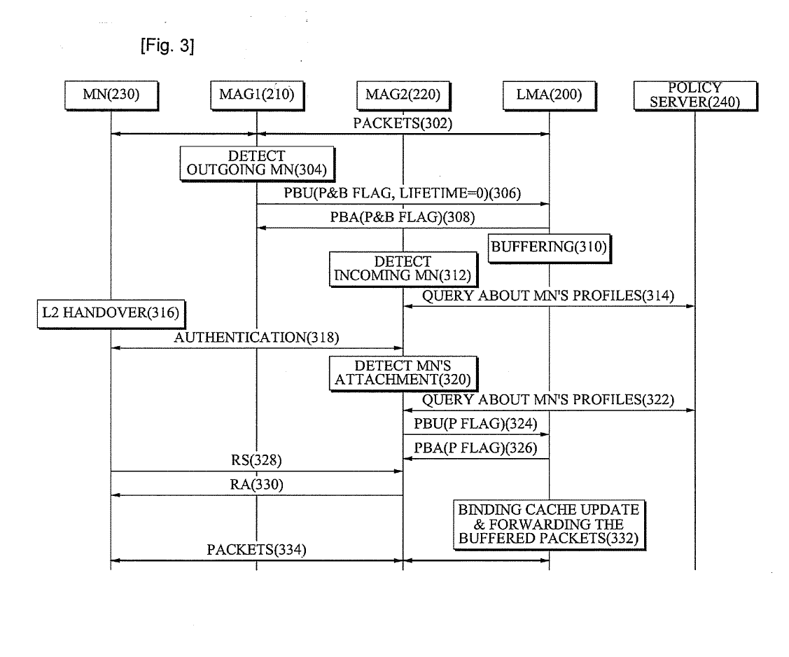

The first MAG 210 in the proxy mobile IPv6 based-network according to the present exemplary embodiment of the invention requests the LAM for packet buffering when detecting the MN 230 not being served by the MAG any more because the MN 230 moves to a service region of the second MAG 220. Next, the LAM buffers packets transmitted to the MN 230 when receiving the request for the packet buffering, and transmits the buffered packet to the MN 230 through the second MAG 220 when establishing a bidirectional tunnel with the second MAG 220. The packet buffering method when the MN 230 moves between the MAGs will be herein described in detail with reference to FIG. 3.

FIG. 3 is a flowchart illustrating a flow of a message for packet buffering when a mobile node is moved between Mobile Access Gateways (MAGs) in a proxy mobile IPv6 based-network according to an exemplary embodiment of the present invention.

Referring to FIG. 3, when the MN 230 is provided with packet services by communicating with the LMA 200 through the first MAG 210 in operation 302 and then is not provided with the packet services any more from the first MAG 210 due to movement of the MN 230, the first MAG 210 may detect the outgoing MN 230 in operation 304, generate a Proxy Binding Update (PBU) message 306 in which a lifetime field value is set to ‘0’ and a packet buffering flag is set, and transmit the generated PBU message 306 to the LMA 200.

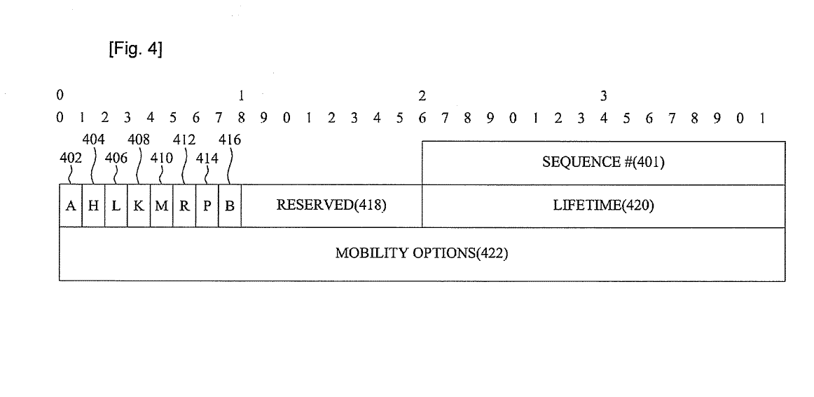

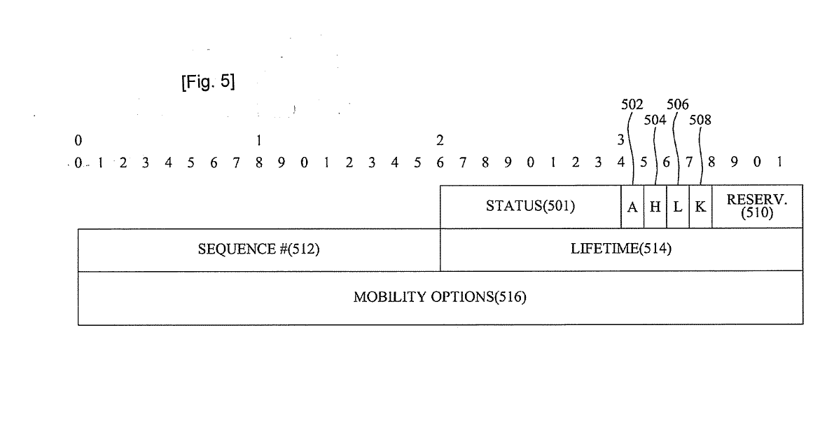

The LMA 200 generates a Proxy Binding Acknowledgement (PBA) message 308 when ascertaining that the lifetime field value of the received PBU message 306 is ‘0’ and the packet buffering flag is set, transmits the generated PBA message 308 to the first MAG, marks the MN 230 whose packets are being buffered in a Binding Cache Entry (BCE) in operation 310 and perform a buffering operation for the packets destined to the MN 230. When the LMA 200 does not receive a PBU message 324, transmitted for registering location information of the corresponding MN, for a specific time interval, the buffering operation is stopped and all the buffered packets are discarded. Meanwhile, configuration of the PBU message 306 and PBU message 308 will be described in detail with reference to FIGS. 4 and 5.

The second MAG 220 may obtain information about incoming MN 230s from the policy store 240 in advance. The obtained information consists of an address of the LMA 200 to which the MN 230 intends to connect, an identifier of the MN 230, and so on. The policy store 240 is a logical component where various setting, information, and the like each required for PMIPv6 operations are stored, and it may exist in an Authentication, Authorization and Accounting (AAA) server. Operation 312 and receiving of various setting and information 314 may occur when the second MAG 220 detects incoming MN 230 in advance, which otherwise may not occur.

Meanwhile, the MN 230 performs handover in operation 316, and then performs an authentication procedure 318 with the second MAG 220.

The second MAG 220 obtains information about attached MN 230 from the policy store 240. The obtained information consists of identification (ID) information 322 of the MN 230, an address of the LMA 200 to which the MN 230 intends to connect and so on. When operations 312 and 314 were performed, operation 322 may be omitted. Then, the second MAG 220 transmits, to the LMA 200, the PBU message 324 in which a lifetime field value is not ‘0’ according to a general proxy mobile IPv6 procedure.

The LMA 200 retrieves BCE information to see whether packets for the corresponding MN are being buffered based on the ID information of the MN 230 included in the PBU message 324, when verifying that the lifetime field value of the received PBU message 324 is not ‘0’. Then, when the packets for the corresponding MN are being buffered according to the checked result, the LMA 200 transmits the corresponding buffered packets to the second MAG 220 in operation 332.

FIG. 4 is a diagram illustrating a format of a Proxy Binding Update (PBU) message according to an exemplary embodiment of the present invention. Referring to FIG. 4, the PBU message according to the present exemplary embodiment of the invention includes a sequence number field 401, an Acknowledge (A) field 402, a Link-Local Address Compatibility (L) field 406, a Key Management Mobility Capability (K) field 408, a MAP Registration Flag (M) field 410, a Mobile Router Flag (R) field 412, a Proxy Registration Flag (P) field 414, a Packet Buffering Flag (B) field 416, a reserved field 418, a lifetime field 420, and a mobility option field 422.

In the sequence number field 401, values indicating a sequence number of the PBU message are recorded. The sequence number field 401 may be used for guaranteeing that continued PBU messages are accurately transmitted in order. In A field 402, values requesting for transmitting the PBA message while simultaneously receiving the PBU message may be recorded. H field 404 may be used for indicating that the PBU message is transmitted to a Home Agent (HA). L field 406 may be used for indicating that an Interface Identifier of a link local address of the MN is the same as an Interface Identifier of a home address of the MN. K field 408 may be used for indicating that a protocol for security association setting between the MN and the HA is reused every time the MN is moved.

In M field 410, values indicating whether the corresponding PBU message in a Hierarchical Mobile IP (HMIP) protocol is transmitted with respect to a Mobility Anchor Point (MAP) different from either the HA or a Corresponding Node (CN) may be recorded. In R field 412, values informing the HA whether the corresponding PBU message in a Network Mobility (NEMO) protocol is transmitted from a Mobile Router may be recorded. In P field 414, values indicating that the corresponding PBU message in the Proxy Mobile IPv6 protocol (PMIP 6) is used for proxy registration may be recorded.

The reserved field 418 is a field being not used and reserved. In the lifetime field 420, values indicating a lifetime of binding may be recorded. When the lifetime field value is ‘0’, the corresponding BCE of the MN may be eliminated. In the mobility option field 422, values indicating mobility options such as binding authorization data option, nonce indices option, alternative Care Of Address (COA) option, and the like may be recorded.

Also, a packet buffering (B) field 416 which is newly added according to the present exemplary embodiment of the invention is used for requesting the LMA for buffering packets destined for a specific MN. When the LMA receives the PBU message in which B field 416 is set to ‘1’, packets transmitted to the corresponding MN are buffered based on MN information informed through the corresponding PBU message. In FIG. 4, remaining fields except B field 416 may follow a conventional standard.

FIG. 5 is a diagram illustrating a format of a Proxy Binding Acknowledgement (PBA) message according to an exemplary embodiment of the present invention. Referring to FIG. 5, the PBA message according to the present exemplary embodiment of the invention includes a status field 501, a Key Management Mobility Capability (K) field 502, a Mobile Router Flag (R) field 504, a Proxy Registration Flag (P) field 506, a Packet Buffering Flag (B) field 508, a reserved field 510, a sequence number field 512, a lifetime field 514, and a mobility option field 516.

In the status field 501, values indicating a processed result of binding update of an MN may be recorded. K field 502 may be used for indicating that a protocol for security association setting between the MN and the HA is reused every time the MN is moved. In R field 504, values indicating that the corresponding PBA message in the NEMO protocol is used as a response from the LMA with respect to the PBU message transmitted from the MGA may be recorded. In P field 506, values indicating that the PBA message in the PMIP6 protocol is used as a response with respect to proxy registration request may be recorded.

The reserved field 510 is a field being not used and reserved. In the sequence number field 512, values indicating a sequence number of the PBU message may be recorded. The sequence number field 512 may be used for matching the PBU message with the PBA message, that is, a response to the PBU message. In the lifetime field 514, values indicating a lifetime of binding may be recorded. In the mobility option field 516, values indicating mobility options such as binding authorization data option, binding refresh advice option, and the like may be recorded.

Also, a packet buffering (B) field 508 newly added according to the present exemplary embodiment of the invention is used for indicating that the corresponding PBA message is a response to the PBU message requesting the LMA for buffering packets destined for a specific MN. In FIG. 5, remaining fields except B field 508 may follow a conventional standard.

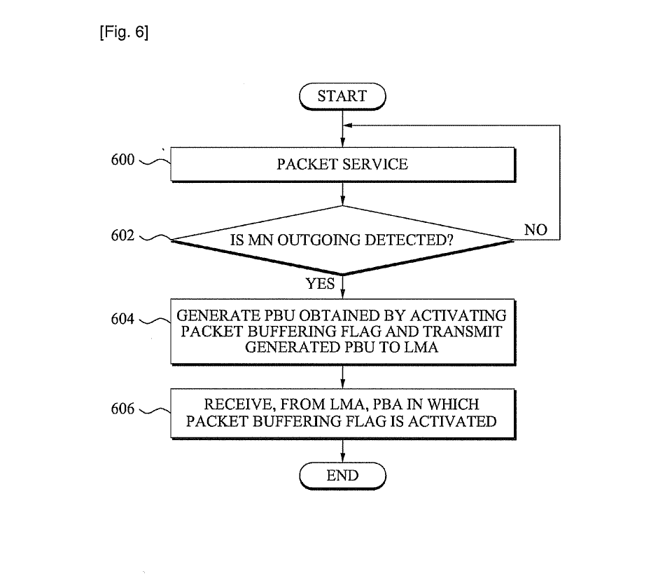

Hereinafter, the packet buffering method for reducing packet loss in the proxy mobile IPv6 according to the present invention constructed as described above will be described in detail with respect to FIG. 6.

FIG. 6 is a diagram illustrating a packet buffering requesting process of a MAG in a proxy mobile IPv6 network according to an exemplary embodiment of the present invention. Referring to FIG. 6, in operation 600, the MAG according to the present exemplary embodiment of the invention establishes a bidirectional tunnel with the LMA, transmits/receives packets transmitted to the MN, and provides packet services to the MN. Next, the MAG may ascertain whether the outgoing MN is detected in operation 602, and repeatedly provide the packet service in operation 600 when the outgoing MN is not detected. In this instance, the outgoing MN denotes that the MN is out of a service region.

However, in operation 604, when the outgoing MN is detected, the MAG generates a PBU message in which the packet buffering (B) flag is set to ‘1’ and a lifetime field value is ‘0’, and transmits the generated PBU message to the LMA. Next, in operation 606, the MAG confirms that the LMA receives the PBU message, by receiving the PBA message in which the packet buffering (B) flag is set, and terminate the algorithm.

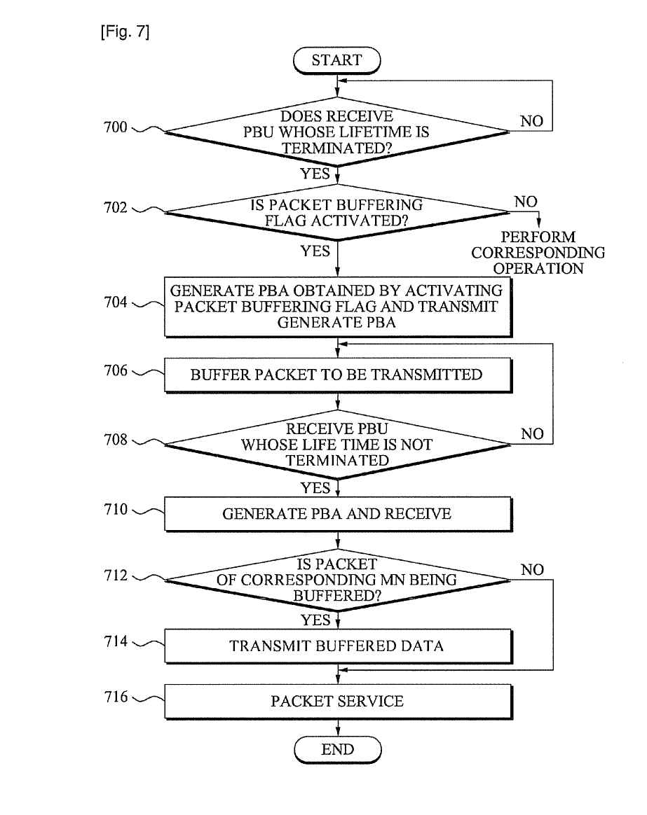

FIG. 7 is a flowchart illustrating a packet buffering process of a Local Mobility Anchor (LMA) in a proxy mobile IPv6 network according to an exemplary embodiment of the present invention. Referring to FIG. 7, in operation 700, the LMA of the present exemplary embodiment of the present invention receives the PBU message whose lifetime is expired. Next, in operation 702, the LMA verifies whether a packet buffering (B) flag of the received PBU message is set to ‘1’. Then, when the packet buffering (B) flag is not set to ‘1’ according to the verified result, the received PBU message is processed according to a convention procedure.

In operation 704, when the packet buffering (B) flag is set to ‘1’ according to the verified result, the LMA generates the PBA message in which the packet buffering (B) flag is set to ‘1’ in response to the received PBU message, and transmits the generated PBA message to the MAG transmitting the PBU message. In operation 706, the LMA verifies information about the MN included in the received PBU message, and buffer a packet transmitted to the corresponding MN.

Next, in operation 708, the LMA verifies whether the PBU message whose lifetime is not expired is received. When the PBU message is not received, the LMA may return to operation 706. Meanwhile, when the PBU message of the MN performing a packet buffering for a predetermined time interval is not received, the packet buffering is stopped, and the packets being buffered are discarded.

In operation 710, the LMA generates the PBA message in response to the PBU message when receiving the PBU message whose lifetime is not expired, and transmits the generated PBA message to the MAG transmitting the PBU message. In operation 712, the LMA verifies whether information about the MN included in the PBU message to check whether a packet transmitted to the corresponding MN is being buffered. In operation 714, when the packet is being buffered according to the checked result, the LMA may transmit the buffered packet data to the MAG transmitting the PBU message whose lifetime is not expired through a bidirectional tunnel. In operation 716, the LMA transmits packets for the MN using the MAG connected through the bidirectional tunnel. When the packets for the corresponding MN is not being buffered according to the checked result of operation 712, the LMA provides a packet service to the MN using the MAG connected through the bidirectional tunnel without forwarding the buffered packets. Then, the algorithm of the present invention is terminated.

As described above, according to the present invention, there are provided the packet buffering apparatus and method for reducing packet loss in the proxy mobile IPv6, which includes the first MAG requesting the LMA for packet buffering when outgoing MN being served by the MAG is detected, and the LMA for buffering the packet transmitted to the corresponding MN when receiving a request for the packet buffering.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. Therefore, it is intended that the scope of the invention be defined by the claims appended thereto and their equivalents.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method for buffering a packet of a Local Mobility Anchor (LMA) in a network based on a proxy mobile Internet Protocol (IP), the method comprising: receiving a request for packet buffering when detecting an outgoing mobile node from a first Mobile Access Gateway (MAG); and buffering packets being transmitted to the corresponding mobile node when receiving the request for the packet buffering.

2. The method of claim 1, wherein the receiving receives the request for the packet buffering using a Proxy Binding Update (PBU) message in which a lifetime field value is ‘0’ and a packet buffering (B) flag is set.

3. The method of claim 2, further comprising: generating a Proxy Binding Acknowledgement (PBA) message in which a packet buffering (B) flag is set in response to the PBU message and transmitting the generated PBA message to the first MAG transmitting the PBU message, when receiving the PBU message requesting packet buffering.

4. The method of claim 2, wherein the PBU message includes a packet buffering (B) flag field indicating a packet being transmitted to the corresponding mobile node is being buffered when set.

5. The method of claim 3, wherein the PBA message includes a packet buffering
(B) flag field indicating a response with respect to a request for buffering the packet being transmitted to the corresponding mobile node.

6. The method of claim 1, further comprising: identifying a mobile node included in a PBU message to see whether the packets for the corresponding mobile node are being buffered when receiving, from the second MAG, the PBU message that indicates an incoming mobile node; and transmitting the packets being buffered to the second MAG when the packets to the corresponding mobile node are being buffered according to the determined result.

7. A method for reducing packet loss of a Mobile Access Gateway (MAG) in a network based on a proxy mobile IP, the method comprising: ascertaining whether a mobile node served by the MAG has been detached; and requesting a Local Mobility Anchor (LMA) for packet buffering when the outgoing mobile node is detected according to the ascertainment.

8. The method of claim 7, wherein the requesting requests the packet buffering by transmitting a Proxy Binding Update (PBU) message in which a lifetime field value is ‘0’ and a packet buffering (B) flag is set.

9. The method of claim 8, further comprising:
verifying whether the PBU message is normally processed by receiving a Proxy Binding Acknowledgement (PBA) message from the LMA in which a packet buffering (B) flag is set after requesting for the packet buffering by transmitting the PBU message.

10. A network based on a proxy mobile Internet Protocol (IP) for reducing packet loss, the network comprising: a first Mobile Access Gateway (MAG) for requesting a Local Mobility Anchor (LMA) for packet buffering when a mobile node served by the MAG has been detached; and the LMA for buffering packets being transmitted to the corresponding mobile node when receiving the request for the packet buffering.

11. The network of claim 10, wherein the packet buffering is requested by using a
Proxy Binding Update (PBU) message in which a lifetime field value is ‘0’ and a packet buffering (B) flag is set.

12. The network of claim 11, wherein when receiving the PBU message requesting the packet buffering, the LMA generates a Proxy Binding Acknowledgement (PBA) message in which a packet buffering (B) flag is set in response to the PBU message and transmits the generated PBA message to the first MAG transmitting the PBU message.

13. The network of claim 11, wherein the PBU message includes a packet buffering (B) flag field indicating whether packets for the corresponding mobile node are buffered or not.

14. The network of claim 12, wherein the PBA message includes a packet buffering
(B) flag field indicating a response with respect to a request for buffering the packets for the corresponding mobile node.

15. The network of claim 10, further comprising: a second MAG for generating a PBU message indicating the incoming mobile node when the incoming mobile node is detected, and transmitting the generated PBU message to the LMA, wherein when receiving, from the second MAG, the PBU message that indicates the incoming mobile node, the LMA verifies whether the packets to the corresponding mobile node are being buffered, and transmits the packets being buffered to the second MAG according to the verified result.

16. The method of claim 3, wherein the PBU message includes a packet buffering (B) flag field indicating a packet being transmitted to the corresponding mobile node is being buffered when set.

17. The network of claim 12, wherein the PBU message includes a packet buffering (B) flag field indicating whether packets for the corresponding mobile node are buffered or not.
